(19) United States
(12) Patent Application Publication
(10) Pub. No.: US 2010/0067655 A1
(43) Pub. Date: Mar. 18, 2010

(54) Radiation image photographing method and apparatus

(75) Inventors: Yoshitaka Yamaguchi, Kanagawa-ken (JP); Tatsuya Aoyama, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/585,432

(22) Filed: Sep. 15, 2009

(30) Foreign Application Priority Data
Sep. 16, 2008 (JP) 2008-235885
Aug. 31, 2009 (JP) 2009-199458

(51) Int. Cl. G01N 23/04; H05G 1/66; H01J 35/00

(52) U.S. Cl. 378/62; 378/93; 378/121

(57) ABSTRACT

A radiation image photographing apparatus capable of easily obtaining a high quality long length image representing the entirety of a subject by combining a plurality of images, without a noticeable step density difference at a joint, obtained by serially radiographing a plurality of adjacent areas of the subject using the same radiation source and the same radiation image detector, in which a photographing condition for performing each radiographing is obtained by a photographing condition obtaining unit, a photographable width in a long length direction in each radiographing is obtained by a photographable range obtaining unit from the photographing condition, and the plurality of areas of the subject is allocated by an allocation unit such that a photographing width in the long length direction in each radiographing does not exceed the photographable width.

### BACKGROUND OF THE INVENTION

1. Field of the Invention

The present invention relates to a radiation image photographing method and apparatus, and more particularly to a radiation image photographing method and apparatus for obtaining a long length radiation image representing the entirety of a subject by combining a plurality of images obtained by serially radiographing a plurality of adjacent areas of the subject.

2. Description of the Related Art

Apparatuses for transmitting radiation, such as an X-ray, through a subject and detecting the radiation to obtain a radiation image representing the subject are known.

As one of the radiation image detectors used for such apparatuses, an FPD (flat panel detector) is known. The FPD is a detector that outputs an image signal representing a radiation image of a subject by detecting radiation transmitted through the subject and converting the radiation to an electrical signal. A radiation image photographing system using the FPD may output an image signal representing the subject immediately (several seconds) after the radiographing.

Further, a radiation image photographing apparatus in which the FPD is serially moved to a plurality of adjacent areas of a subject to perform radiographing and a plurality of images obtained by each radiographing is combined to obtain a long length radiation image representing the entire subject, for example, an entire spine image or an entire lower leg image is known.

For the radiographing for obtaining such long length radiation images, a method in which the position of the radiation source is fixed and the orientation of the radiation source is directed to the FPD with respect to each radiographing operation performed by serially moving one FPD is known. That is, a method in which each radiographing operation is performed by directing a specific range of the emission range of radiation emitted from the radiation source to the FPD is known.

As such type of method, for example, a method in which radiographing is performed by setting the position and orientation of the radiation source such that the emission center axis that passes the center of emission range of radiation emitted from the radiation source is aligned with the center of the FPD with respect to each radiographing operation performed by serially moving the FPD is known.

Further, a method in which each radiographing operation is performed by sequentially translating the positions of the radiation source and FPD with respect to the subject, i.e., without changing the relative positional relationship between the radiation source and FPD is also known.

In the mean time, the X-ray tube has greater radiation intensity on the cathode side than on the anode side, so that the radiation emitted from the radiation source has an asymmetrical intensity distribution with respect to the emission center axis which is the boundary between the cathode and anode sides. The phenomenon of such an asymmetrical intensity distribution is called heel effect.

The emission unevenness of radiation due to such intensity distribution is also recognized in the radiation used for each radiographing operation for obtaining a long length radiation image. Consequently, for example, when obtaining a radiation image which is long in the up-down direction, a density distribution occurs from an upper edge portion to a lower edge portion of each image obtained by each radiographing operation. As a result, for example, a density difference may sometimes occur between a lower edge portion of a particular radiation image and an upper edge portion of another image adjacent to the lower side of the particular radiation image, thereby a step difference in density (step density difference) is generated at the boundary between the particular image and another image adjacent to the particular image.

That is, when obtaining a long length radiation image representing an entire subject by combining a plurality of images obtained by radiographing, a step difference in density may sometimes be generated at the joint of the combined image.

In such a case, for example a method that performs image processing using correction data obtained by separately performing radiographing, thereby correcting such a step density difference is known as described, for example, in Japanese Unexamined Patent Publication No. 2006-141905. Further, a method for preventing such a step density difference is also conceivable in which radiographing is performed by reducing the distance from an upper edge portion to a lower edge portion of a target area for one radiographing operation, i.e., by reducing the width (photographing width) of each area of a subject in a long length direction based on, for example, a value empirically obtained by a radiological technologist or the like.

The method for correcting a step density difference by image processing described above, however, requires separate radiographing for obtaining correction data, causing a problem of great burden of radiographing. In addition, the method in which the setting of radiographing is changed based on an empirical value of a radiological technologist or the like may not reduce the step density difference at a joint portion between images to a degree less than a desired level (sufficiently unnoticeable level).

Consequently, there is a demand for reliably making a step density difference that may occur at a joint portion between combined images unnoticeable without increasing the burden of radiographing when obtaining a long length radiation image.

The present invention has been developed in view of the circumstances described above, and it is an object of the present invention to provide a radiation image photographing method and apparatus capable of easily obtaining a high-quality long length image without a noticeable step density difference at a joint portion.

### SUMMARY OF THE INVENTION

A radiation image photographing apparatus of the present invention is an apparatus for obtaining a long length radiation image representing the entirety of a subject by combining a plurality of images obtained by serially radiographing a plurality of adjacent areas of the subject using the same radiation source and the same radiation image detector, the apparatus including:

a photographing condition obtaining unit for obtaining a photographing condition for performing each radiographing operation;

a photographable range obtaining unit for obtaining a photographable width in a long length direction in each radiographing operation from the photographing condition; and

an allocation unit for allocating the plurality of areas of the subject such that a photographing width in the long length direction in each radiographing operation does not exceed the photographable width.

The radiation image photographing apparatus may be an apparatus for obtaining a long length radiation image representing the entirety of a subject by combining a plurality of images obtained by serially radiographing a plurality of adjacent areas of the subject using the same radiation source and the same radiation image detector, including:

a photographing condition obtaining unit for obtaining a photographing condition for performing each radiographing operation;

a photographable range obtaining unit for obtaining, with respect to a long length radiation image to be obtained by the serial radiographing operations under the photographing condition, a photographable width in a long length direction in each radiographing operation that does not cause a step density difference due to heel effect at a joint portion between each image constituting the long length image from the photographing condition corresponding to each radiographing operation; and

an allocation unit for allocating the plurality of areas of the subject such that a photographing width in the long length direction in each radiographing operation does not exceed the photographable width corresponding to each radiographing operation.

The photographing condition may be a photographing distance, a dose of radiation emitted from the radiation source, a tube focus size, or a tube target material of the radiation source.

Preferably, the photographable range obtaining unit is a unit that obtains the photographable width when a radiation bundle portion having smallest emission unevenness due to heel effect in a radiation bundle outputted from the radiation source is emitted to each area of the subject.

Preferably, the radiation image photographing apparatus is an apparatus further including a tube bobbing unit for changing an orientation of the tube of the radiation source in the long length direction.

A radiation image photographing method of the present invention is a method for obtaining a long length radiation image representing the entirety of a subject by combining a plurality of images obtained by serially radiographing a plurality of adjacent areas of the subject using the same radiation source and the same radiation image detector, the method including the steps of:

obtaining a photographing condition for performing each radiographing operation;

obtaining a photographable width in a long length direction in each radiographing from the photographing condition; and

allocating the plurality of areas of the subject such that a photographing width in the long length direction in each radiographing does not exceed the photographable width.

The radiation image photographing method may be a method for obtaining a long length radiation image representing the entirety of a subject by combining a plurality of images obtained by serially radiographing a plurality of adjacent areas of the subject using the same radiation source and the same radiation image detector, including the steps of:

obtaining a photographing condition for performing each radiographing operation;

obtaining, with respect to a long length radiation image to be obtained by the serial radiographing operations under the photographing condition, a photographable width in a long length direction in each radiographing operation that does not cause a step density difference due to heel effect at a joint portion between each image constituting the long length image from a photographing condition corresponding to each radiographing operation; and

allocating the plurality of areas of the subject such that a photographing width in the long length direction in each radiographing operation does not exceed the photographable width corresponding to each radiographing operation.

According to the radiation image photographing method and apparatus of the present invention, a photographing condition for each radiographing operation is obtained, then a photographable width in a long length direction in each radiographing operation is obtained from the photographing condition, and a plurality of areas of a subject is allocated such that a photographing width in the long length direction does not exceed the photographable width. This allows a high quality long length image, without a noticeable step density difference at a joint portion of each image constituting the long length image to be obtained easily.

That is, the intensity distribution of radiation emitted to a subject may be accurately estimated from the photographing condition, and a photographable width in the long length direction in each radiographing operation that does not cause a step density difference due to heel effect at a joint portion between each image constituting the long length image may be accurately obtained from the photographing condition corresponding to each radiographing operation. Further, Performance of each radiographing operation by setting the photographing width not exceeding the photographable width corresponding to each radiographing operation may reduce a step density difference that may occur at a joint portion of each image constituting a long length image to an unnoticeable level.

Further, the use of photographing distance, dose of radiation emitted from the radiation source, tube focus size, or tube target material as the photographing condition allows the photographable width in the long length direction to be obtained reliably.

Still further, when the photographable range obtaining unit is a unit that obtains the photographable width when a radiation bundle portion having smallest emission unevenness due to heel in a radiation bundle outputted from the radiation source is emitted to each area of the subject, a long length image without a noticeable step density difference at a joint portion of each image may be obtained more reliably.

Further, if a tube bobbing unit for changing the orientation of the tube of the radiation source is provided, a long length image without a noticeable step density difference at a joint portion of each image may be obtained more reliably.

Still further, when the photographing width is set to a maximum value within the range of photographable width, the radiographing may be performed efficiently without increasing the number of radiographing operations by unnecessarily reducing the radiographing target area.

### BRIEF DESCRIPTION OF THE DRAWINGS

FIG. 1 is a schematic configuration diagram of a radiation image photographing apparatus according to an embodiment of the present invention.

FIG. 2 illustrates radiation beams emitted from a tube target.

FIG. 3 illustrates a radiation intensity distribution of areas exposed to radiation emitted from the tube target.

FIG. 4 illustrates the difference in magnitude of emission unevenness due to the difference in tube focus size.

FIG. 5 illustrates the difference in magnitude of emission unevenness due to the difference in tube target material.

FIG. 6 illustrates radiation intensity distributions on the radiation detection surface in four radiographing operations.

FIG. 7 illustrates radiation intensity distributions on the radiation detection surface in three radiographing operations.

FIG. 8 illustrates a radiation intensity distribution on the radiation detection surface in one radiographing operation.

FIG. 9 shows a comparison between a long length radiation image obtained by four radiographing operations and a long length radiation image obtained by three radiographing operations.

FIG. 10A illustrates an intensity distribution when a bundle of radiation emitted from a tube is detected with the emission center axis arranged orthogonal to the detection plane.

FIG. 10B illustrates an intensity distribution when a bundle of radiation emitted from a tube is detected with the emission center axis inclined to the detection plane.

### DESCRIPTION OF THE PREFERRED EMBODIMENTS

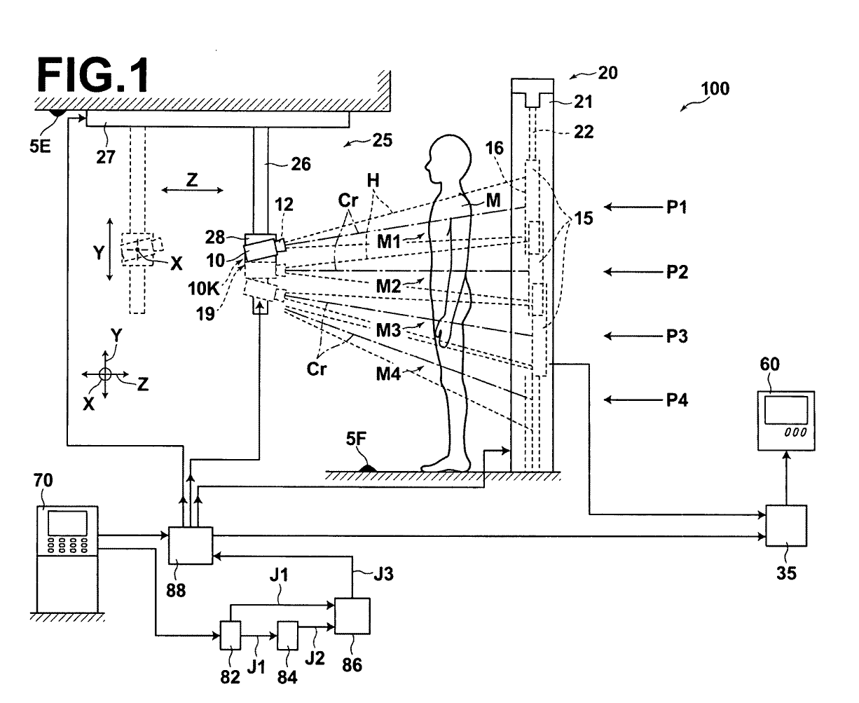

Hereinafter, an exemplary embodiment of the present invention will be described with reference to the accompanying drawings. FIG. 1 is a conceptual diagram of an example radiation image photographing apparatus for implementing a radiation image photographing method according to an embodiment of the present invention, illustrating a schematic configuration thereof.

Radiation image photographing apparatus 100 of the present invention illustrated in FIG. 1 is an apparatus for obtaining a long length radiation image representing the entirety of subject M by combining a plurality of images obtained by serially radiographing a plurality of adjacent areas M1, M2, . . . of subject M using the same radiation source 10 and the same radiation image detector 15.

Radiation image photographing apparatus 100 includes photographing condition obtaining unit 82 that obtains a photographing condition, photographable width obtaining unit 84 that obtains, with respect to a long length radiation image to be obtained by serially performing radiographing operations under the photographing condition, a photographable width for each radiographing operation in long length directions (arrow Y directions in FIG. 1) that does not cause a step density difference due to heel effect from the photographing condition so that a step density difference does not appear at the joint (boundary) between each image constituting the long length radiation image, and allocation unit 86 that allocates a plurality of areas M1, M2, . . . of radiographing target subject M (frame allocation) such that the radiographing width in each radiographing operation in the long length direction does not exceed the photographable width of the radiographing.

Photographing condition obtaining unit 82 obtains photographing distance data, dose data of radiation emitted from radiation source 10, focus size data of tube K of radiation source 10, data indicating the material of the tube target disposed in radiation source 10, and the like, as photographing conditions.

Radiation image photographing apparatus 100 includes radiation source that emits radiation H, radiation image detector 15 that detects radiation H, detector moving unit 20 that moves radiation image detector 15 along subject M, radiation source positioning unit 25 that performs positioning of radiation source. Radiation image detector 15 has radiation detection surface 16 that receives radiation H emitted from radiation source 10 and transmitted through subject M, and detects an intensity distribution of radiation H.

Radiation image detector 15 may use an FPD (flat panel detector) that outputs an image signal representing a radiation image of subject M by detecting radiation H transmitted through subject M and converting the radiation to an electrical signal. The FPD may output image data representing subject M immediately (several seconds) after the radiographing operation.

Detector moving unit 20 holds radiation image detector 15 between two posts standing upright (arrow Y directions in FIG. 1) from a floor surface 5F and has moving mechanism 22 for moving radiation image detector 15 in the extending direction of the posts (up-down direction), i.e., the long length direction. Moving mechanism 22 may be a mechanism that supports radiation image detector 15 by a known linear sliding mechanism or the like and moves the detector using a drive source, such as a motor.

When performing radiographing operations for obtaining a long length radiation image, subject M is placed along moving directions of radiation image detector (arrow Y directions in FIG. 1). That is, radiographing operations are performed while having subject M to stand on the floor surface.

Radiation source positioning unit 25 is a unit for holding and moving radiation source 10 so as to face radiation detection surface 16 of radiation image detector 15 (arrow Z directions in FIG. 1) over subject M. Radiation source positioning unit 25 includes post 26 vertically extending from ceiling 5E, ceiling base 27 for moving post 26 in a facing direction (arrow Z directions in FIG. 1) along ceiling 5E, and a rotation platform 28 engaged with post 26 and movable in a vertical direction (arrow Y directions in FIG. 1), and rotatable around an axis perpendicular to the surface of FIG. 1 (axis parallel to X-axis perpendicular to the Y-Z surface in FIG. 1).

Radiation source 10 is placed on the rotation platform 28, and the radiation source 10 is movable by radiation source positioning unit 25 in up-down directions (arrow Y directions in FIG. 1) and left-right directions (arrow Z directions in FIG. 1), and rotatable around an axis passing through an approximate center of radiation source 10 and is parallel to X-axis in FIG. 1 through rotation platform 28.

Further, tube bobbing unit 19 changes the orientation of tube 10K disposed in radiation source 10 along long length directions (arrow Y directions in FIG. 1). Here, tube bobbing unit 19 is a unit that changes the orientation of tube 10K with respect to the body of radiation source 10.

The mechanism for operating radiation source positioning unit 25 or tube bobbing unit 19 may be formed using known linear sliding mechanism, rotation mechanism, and drive source, such as a motor.

Radiation image photographing apparatus 100 includes long length photographing control unit 88 for causing detector moving unit 20 to serially move radiation image detector 15 to each of positions P1, P2, . . . for performing radiographing operations along an extending direction of subject M (long length direction), causing radiation source positioning unit 25 to position radiation source 10 such that the emission direction of radiation H from radiation source 10 is oriented to radiation detection surface 16, and performing control such that radiographing is performed at each position for each of adjacent areas M1, M2, . . . of subject M, image combining unit 35 for combining each image portion obtained by each radiographing operation to obtain a long length radiation image representing the entirety of subject M, and display 60 that displays the long length radiation image combined by image combining unit 35.

Allocation unit 86 that allocates a plurality of areas M1, M2, . . . of radiographing target subject M receives photographable width information J2 from photographable width obtaining unit 84 and photographing condition information J1 indicating a photographing condition from photographing condition obtaining unit 82, and outputs allocation information J3 for allocating a photographing width for each radiographing operation and photographing positions P1, P2 such that a long length radiation image is obtained without any noticeable joint portion.

Here, allocation unit 86 may be configured to receive photographing condition information J1 and photographing width information J2 from photographable width obtaining unit 84.

Allocation information J3 outputted from allocation unit 86 is inputted to long length photographing control unit 88, and long length photographing control unit 88 controls each unit based on allocation information J3, whereby the position and posture of radiation source 10, the position of radiation image detector 15, and the like are set for each radiographing operation.

Long length photographing control unit 88 receives data of photographing width, photographing position, and the like for each radiographing operation from allocation unit 86, and controls also the orientation of tube 10K of radiation source 10 according to the photographing width, photographing position, and the like.

Console 70 receives subject information of subject M and a photographing condition for obtaining a long length radiation image, which are outputted to photographing condition obtaining unit 82 and long length photographing control unit 88.

The overall operation of radiation image photographing apparatus 100 and the timing of each operation are controlled by console 70.

Note that photographing condition obtaining unit 82, photographable width obtaining unit 84, allocation unit 86, long length photographing control unit 88, image combining unit 35, and the like may be provided in the console 70.

<Emission Unevenness of Radiation Due to Heel Effect>

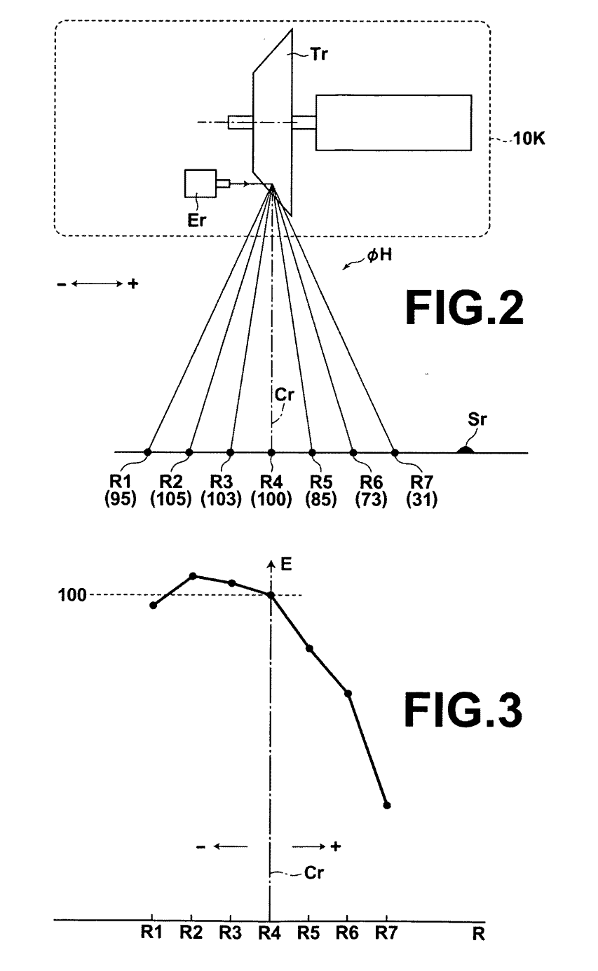

FIG. 2 shows the inside of a tube for emitting radiation provided in radiation source 10, and illustrates the radiation emitted from tube target Tr electron-irradiated by electron gun Er. FIG. 3 illustrates a radiation intensity distribution of areas exposed to radiation emitted from tube target Tr plotted in coordinates with horizontal axis R representing the position on a detection surface for detecting the radiation and vertical axis E representing the intensity of detected radiation.

As shown in FIG. 2, radiation bundle φH emitted from tube target Tr electron-irradiated by electron gun Er, i.e, from tube 10K of radiation source 10 is extended radially centered on emission center axis passing the center of radiation bundle φH and exposes detection surface Sr. Position R4 is a position on detection surface Sr intersecting with emission center axis Cr. Positions R3, R2, and R1 where the radiation reaches are indicated at equal intervals on the − arrow side in FIG. 2 and positions R5, R6, and R7 where the radiation reaches are indicated at equal intervals on the + arrow side in FIG. 2 centered on position R4 on detection surface Sr.

An example of radiation intensities detected on detection surface Sr are that, when assuming the radiation intensity detected, for example, at position R4 on emission center axis Cr to be a value 100 (unit is omitted), the values at positions R3, R2, and R1 on the cathode side indicated by the − arrow in FIG. 2 are 103, 105, and 95 respectively. On the other hand, the values at positions R5, R6, and R7 on the anode side indicated by the + arrow in FIG. 2 are 85, 73, and 31 respectively.

FIG. 3 plots the radiation intensity at each of the positions R1 to R7 to schematically illustrate a radiation intensity distribution on detection surface Sr.

As shown in FIGS. 2 and 3, radiation bundle φH emitted from the radiation source has an asymmetrical intensity distribution with respect to emission center line Cr. The emission unevenness of radiation bundle φH is caused by heel effect. The heel effect produces an asymmetrical intensity distribution in which the radiation intensity on the cathode side of the tube (the − arrow side, i.e., the side of position R1 in FIG. 3) is greater than that on the anode side (the + arrow side, i.e., the side of position R7 in FIG. 3). Emission center axis Cr is located at the boundary between the cathode side and anode side.

Here, the radiation arriving at position R7 travels a longer distance than that of the radiation arriving at R1 when passing through tube target Tr and is absorbed more, thereby showing greater radiation intensity attenuation.

When, for example, the detection target range of emission unevenness due to the heel effect is the range from position R1 to position R7 on detection surface Sr, the magnitude of emission unevenness may be calculated as the difference in radiation intensity between position R1 and position R7 (95−31=64).

<Difference in Emission Unevenness Due to Difference in Tube Focus Size>

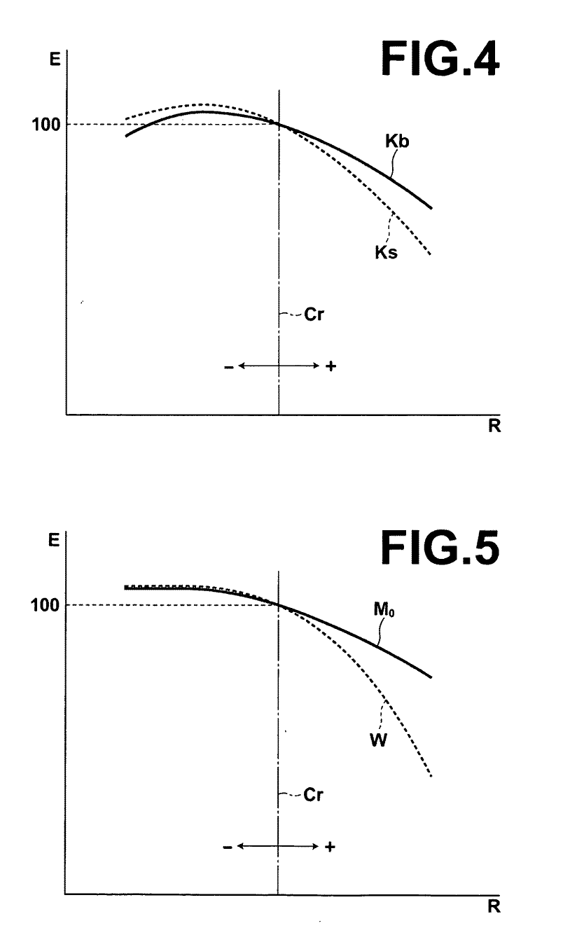

FIG. 4 illustrates the difference in magnitude of emission unevenness due to heal effect arising from the difference in tube focus size plotted in coordinates with horizontal axis R representing the position on a detection surface for detecting the radiation and vertical axis E representing the intensity of detected radiation. The graph shows the radiation intensity at each position with the radiation intensity at emission center axis Cr as a value of 100, as in the above.

As illustrated in FIG. 4, the attenuation of radiation intensity on the anode side area (+ arrow side in FIG. 4) exposed by radiation emitted from tube Kb having a large focus size is smaller than that of radiation intensity on the anode side area (+ arrow side in FIG. 4) exposed by radiation emitted from tube Ks having a small focus size. In the mean time, the radiation intensity on the cathode side area (− arrow side in FIG. 4) is substantially constant regardless of the focus size. That is, the emission unevenness of tube Kb having a large focus size is smaller than that of tube Ks having a small focus size.

Thus, with respect to focus size of the tube which is a photographing condition, the emission unevenness due to heel effect is increased as the focus size of the tube is decreased. Therefore, photographable width obtaining unit 84 determines the photographable width such that the smaller the focus size the smaller the photographable width.

<Difference in Emission Unevenness Due to Difference in Tube Target Type>

FIG. 5 illustrates the difference in magnitude of emission unevenness due to heal effect arising from the difference in tube target type plotted in coordinates with horizontal axis R representing the position on a detection surface for detecting the radiation and vertical axis E representing the intensity of detected radiation. The graph shows the radiation intensity at each position with the radiation intensity at emission center axis Cr as a value of 100, as in the above.

As illustrated in FIG. 5, the attenuation of radiation intensity M₀ on the anode side (+ arrow side in FIG. 5) for radiation emitted from a radiation source that uses a molybdenum material as the tube target is greater than that of radiation intensity W on the anode side (+ arrow side in FIG. 5) for radiation emitted from a radiation source that uses a tungsten material as the tube target. In the mean time, the radiation intensity on the cathode side (− arrow side in FIG. 5) is substantially constant regardless of the difference in the tube target.

Therefore, with respect to the material of the tube target of the radiation source which is a photographing condition, when an anode side radiation bundle is used, photographable width obtaining unit 84 determines the photographable width when tungsten is used for the tube target smaller than that when molybdenum is used for the tube target. When a cathode side radiation bundle is used, photographable width obtaining unit 84 determines the photographable width when tungsten is used for the tube target identical to that when molybdenum is used for the tube target.

<Difference in Photographable Width Due to Difference in Radiation Dose>

With respect to the dose of radiation emitted from radiation source which is a photographing condition, emission unevenness of radiation due to heel effect is increased as the dose of radiation is increased. Therefore, photographable width obtaining unit 84 determines the photographable width such that the greater the radiation dose, the smaller the photographable width.

That is, when the dose of radiation emitted from the radiation source changes due to, for example, a change in the tube voltage, the radiation intensity distribution of the radiation detected by the radiation detector substantially remains the same. When two types of images obtained by radiation of different doses are visually compared, however, the contrast of an image obtained by receiving radiation of great dose becomes high, and the contrast of an image obtained by receiving radiation of small dose becomes lower than that of the image obtained by receiving radiation of great dose. Consequently, photographable width obtaining unit 84 determines the photographable width such that the greater the dose of radiation emitted from the radiation source, the smaller the photographable width.

<Difference in Photographable Width Due to Difference in Photographing Distance>

With respect to photographing distance which is a photographing condition, photographable width obtaining unit 84 determines the photographable width such that the smaller the photographing distance, the smaller the photographable width, and greater the photographing distance the greater the photographable width.

An operation of radiation image photographing apparatus 100 will now be described.

First, a description will be made of a case in which radiographing is performed by setting the orientation of tube 10K, i.e., the orientation of radiation bundle pH such that emission center axis Cr of radiation emitted from tube 10K of radiation source 10 passes through the center of photographing width in a long length direction in each radiographing operation. Then, a description will be made of a case in which the orientation of tube 10K, i.e., the orientation of radiation bundle pH is determined such that the position through which emission center axis Cr passes is displaced from the center of photographing width in a long length direction in each radiographing operation in order to reduce the emission unevenness due to heel effect.

<Default Setting for Radiographing>

Console 70 has therein default setting for obtaining a standard long length radiation image stored in advance. In the default setting, a long length radiation image is obtained by three radiographing operations, and the radiographing is performed by setting the orientation of tube 10K, i.e., the orientation of radiation bundle (pH such that emission center axis Cr of radiation emitted from tube 10K of radiation source 10 passes through the center of photographing width in a long length direction in each radiographing operation.

That is, in the default setting, the radiographing is performed by setting the orientation of tube 10K such that the emission width of radiation bundle on the cathode side corresponds to the emission width of radiation bundle on the anode side within the range of photographing width in a long length direction in each radiographing operation.

<Radiographing Considering Variation in Magnitude of Emission Unevenness Due to Heel Effect>

Subject information, which is information of subject M, a photographing condition, and the like are inputted by operating console 70. The subject information, photographing condition, and the like are transferred and inputted to photographing condition obtaining unit 82 and long length photographing control unit 88.

Photographable width obtaining unit 84 obtains a photographable width in a long length direction considering the magnitude of emission unevenness of the radiation due to heel effect when the radiation outputted from radiation source 10 is emitted on radiation detection surface 16 using the photographing condition obtained by photographing condition obtaining unit 82.

More specifically, photographable width obtaining unit 84, with respect to a long length radiation image to be obtained by serially performing radiographing operations, obtains a photographable width in the long length direction in each radiographing operation which does not cause a step density difference due to heel effect at a joint portion (boundary) of each image constituting the long length radiation image from the photographing condition described above.

That is, with respect to the long length radiation image to be obtained by serially performing radiographing operations under the photographing condition described above, photographable width obtaining unit 84 obtains a photographable width in the long length direction in each radiographing operation which reduces a step density difference due to heel effect at a joint portion (boundary) of each image constituting the long length radiation image to a degree less than a predetermined level (unnoticeable level) from the photographing condition described above.

Allocation unit 86 allocates a plurality of areas M1, M2, . . . of radiographing target subject M such that the photographing width in the long length direction does not exceed the photographable width in each radiographing operation based on the inputted photographable width information obtained by photographable width obtaining unit 84.

Photographable width obtaining unit 84 determines a photographing width in each radiographing operation such that the emission unevenness of the radiation outputted from tube 10K and emitted to each area of subject M becomes not greater than the predetermined level that makes the step density difference unnoticeable under the inputted photographing condition.

Here, the photographable width in the long length direction determined by photographable width obtaining unit 84 becomes smaller than that in the default setting. Therefore, allocation unit 86 allocates a photographing area corresponding to each area of subject M (frame allocation) such that a long length radiation image is obtained by four radiographing operations by reducing the photographing width in the long length direction in each radiographing operation.

Long length photographing control unit 88 receives allocation data generated by allocation unit 86 and controls disposition of radiation source 10 and tube 10K, position of radiation image detector 15, and the like in each radiographing operation to determine the photographing width in the long length direction and photographing position in each radiographing operation such that a long length radiation image is obtained by four radiographing operations.

More specifically, long length photographing control unit 88 receives the photographing width in the long length direction, photographing position, allocation of photographing areas, ratio between radiation bundles on the cathode and anode sides, and the like when a long length radiation image is obtained by four radiographing operations from console 70 and allocation unit 86, and controls detector moving unit 20, radiation source positioning unit 25, tube bobbing unit 19, image combining unit 35, and the like.

Each image representing each of areas M1, M2, . . . of subject M obtained by the control of long length photographing control unit 88 and information of the radiographing outputted from the long length photographing control unit 88 are inputted to image combining unit 35, and image combining unit 35 combines each image to form a long length radiation image. The long length image formed by image combining unit 35 is inputted to display 60.

With regard to the photographable width in the long length direction obtained by photographable width obtaining unit 84, image data (image data representing density distributions caused by heel effect) obtained by radiographing operations under several different photographing conditions may be stored for use in determining the photographable width in the long length direction. For example, information indicating the density distribution of a directly exposed image, obtainable when a photographing target object does not exist, may be obtained under various different photographing conditions and stored. Then, with respect to directly exposed portions of a plurality of images (image portions without photographing target object) obtainable by actually performing radiographing operations in series, the width in the long length direction in which the difference in JND value (just noticeable difference index) of adjacent pixels across the joint portion (boundary) of the images is not greater than a certain value may be obtained as the photographable width. Here, “not greater than a certain value” may be, for example, the difference in JND value of adjacent pixels across the joint is not greater than 0.01.

For example, emission unevenness due to heel effect may be reduced to less than a desired level if each radiographing operation is performed by using Re—W (alloy of tungsten doped with rhenium) tube target, and setting a spread angle to 12 degrees and a photographable width to 20 cm when the photographing distance is 100 cm (to 30 cm when the photographing distance is 120 cm).

<Emission Unevenness in Long Length Image Radiography>

Hereinafter, emission unevenness of radiation due to heel effect when radiographing for obtaining a long length radiation image will be described. Here, the description will be made of a case in which each image portion is obtained through a subject having a radiation transmission factor of 100%.

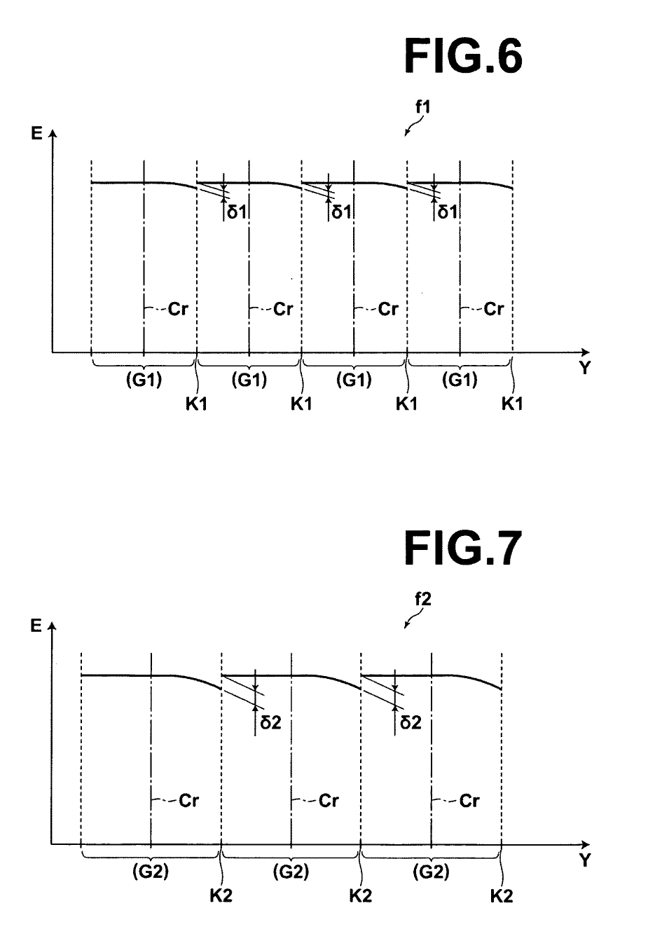

FIG. 6 illustrates intensity distribution f1 of radiation emitted onto the entirety of the subject when a long length radiation image is obtained by four radiographing operations plotted in coordinates with vertical axis E representing the radiation intensity and horizontal axis Y representing the position in the long length direction. The graph shows emission unevenness of radiation when the long length radiation image is obtained by four radiographing operations according to the change in the photographing conditions.

FIG. 7 illustrates intensity distribution f2 of radiation emitted onto the entirety of the subject when a long length radiation image is obtained by three radiographing operations plotted in coordinates with vertical axis E representing the radiation intensity and horizontal axis Y representing the position in the long length direction. The graph shows an emission unevenness of radiation when a long length radiation image is obtained by default setting value of three radiographing operations even though the emission unevenness due to heel effect becomes greater than that of default setting by the change in photographing condition described above.

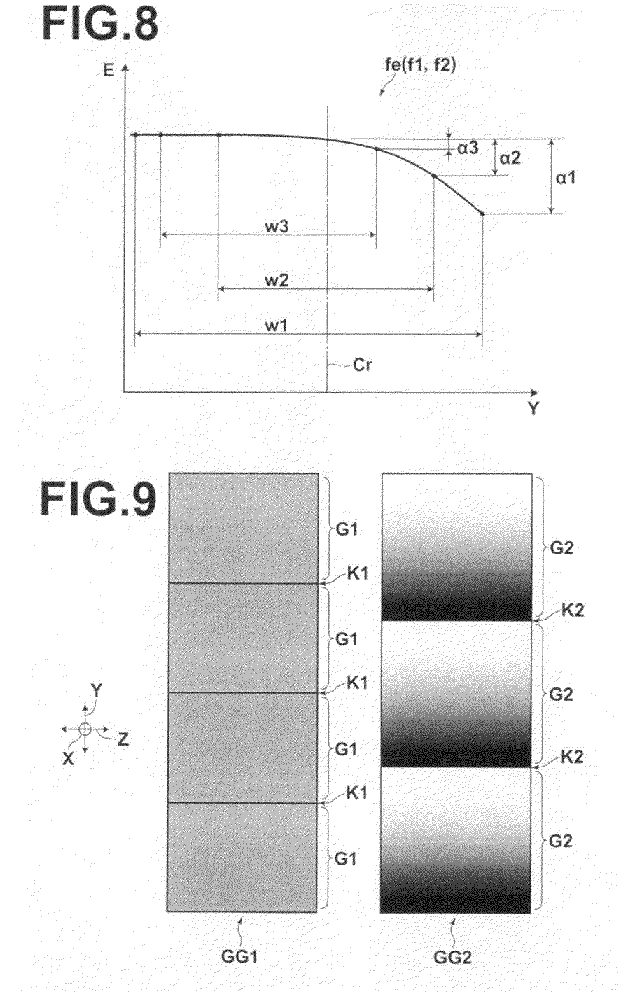

FIG. 8 illustrates intensity distribution fe of radiation emitted onto the radiation detection surface plotted in coordinates with vertical axis E representing the radiation intensity and horizontal axis Y representing the position in the long length direction. The graph shows changes in emission unevenness of radiation according to the setting of use range in intensity distribution fe of radiation emitted by one radiographing operation. That is, the graph shows changes in emission unevenness of radiation according to the photographing width in performing each radiographing operation.

As illustrated in FIG. 7, the intensity distribution of each radiation used for obtaining each image portion G2 (FIG. 9) in three radiographing operations is substantially identical to each other, and a step difference of intensity distribution (step intensity difference δ2) is generated at radiation detection position K2 corresponding to the joint portion (boundary) of each image portion G2 caused by the asymmetry of radiation intensity distribution due to heel effect.

In the mean time, as illustrated in FIG. 6, the intensity distribution of each radiation used for obtaining each image portion G1 (FIG. 9) in four radiographing operations is substantially identical to each other, and a slight step difference of intensity distribution (step intensity difference δ1) is generated at radiation detection position K1 corresponding to the boundary of each image portion G1 caused by the asymmetry of radiation intensity distribution due to heel effect. That is, the step intensity difference δ1 generated in intensity distribution f1 when obtaining a long length radiation image by four radiographing operations is smaller than the step intensity difference δ2 generated in intensity distribution f2 when obtaining a long length radiation image by three radiographing operations (δ1<δ2).

As shown in FIG. 8, radiation emitted from the radiation source in each of four radiographing operations and radiation emitted from the radiation source in each of three radiographing operations are portions of the radiation having intensity distribution fe, the magnitude of emission unevenness of the radiation due to heel effect changes according to the range of intensity distribution fe used for obtaining image portions (G1, G2).

That is, the range of intensity distribution fe of radiation used in each of three radiographing operations is the range denoted by reference symbol W1, and the magnitude of emission unevenness of the radiation due to heel effect is difference al between the ends of range W1. In the mean time, the range of intensity distribution fe of radiation used in each of four radiographing operations is the range denoted by reference symbol W2, which is narrower than range W1 described above, and the magnitude of emission unevenness is difference α2 between the ends of range W2 (α2<α1).

FIG. 9 shows a comparison between a long length radiation image obtained by four radiographing operations and a long length radiation image obtained by three radiographing operations.

As shown in FIG. 9, long length radiation image GG1 obtained by combining four image portions having a small width obtained by four radiographing operations may have a smaller step density difference generated at the joint portion (boundary) of adjacent image portions than that of long length radiation image GG2 obtained by combining three image portions having a large width obtained by three radiographing operations.

In the description with reference to FIG. 8, it has been shown that the magnitude of emission unevenness of radiation due to heel effect can be reduced (α2<α1) by reducing the range of radiation intensity distribution fe used for radiographing from W1 to W2 (i.e., by reducing photographing length in the long length direction). However, the use of a range with a less variation in radiation intensity distribution, e.g., range W3 may further reduce the magnitude of emission unevenness of radiation. But, in such a case, emission center axis Cr is located in a position other than the center of the photographing width in the long length direction in each radiographing operation, i.e., a position displaced from the center of photographing width in each radiographing operation.

More specifically, rang W3 in the radiation bundle is set such that the emission range of the radiation bundle on the cathode side is greater than the emission range of the radiation bundle on the anode side, and as the emission range of the radiation bundle on the cathode side is increased, radiation emission unevenness due to heel effect in range W3 may be reduced more.

In order to make the joint portion of image portions constituting a long length radiation image unnoticeable, it is preferable that each radiographing operation is performed by setting the orientation of tube 10K such that the emission range of the radiation bundle on the cathode side becomes greater than that of the radiation bundle on the anode side within the photographing width in each radiographing operation.

That is, when radiographing for obtaining a long length radiation image is performed by radiation image photographing apparatus 100, it is preferable that the operation of photographing condition obtaining unit 82, photographable width obtaining unit 84, allocation unit 86, long length photographing control unit 88, and the like is based on the assumption that the orientation of tube 10K is determined such that each of areas M1, M2, . . . of subject M is exposed by the radiation having a greater emission range of radiation bundle on the cathode side than that on the anode side in each radiographing operation.

For example, the ratio between the emission range of radiation bundle on the cathode side and the emission range of radiation bundle on the anode side may be automatically determined by controller 70 such that the ratio of radiation bundle on the cathode side becomes maximal, or the ratio may be inputted to controller 70 by the operator.

Hereinafter, a comparison will be made between the case in which the ratio of the emission range of radiation bundle on the cathode side is set equal to that of the emission range of radiation bundle on the anode side and the case in which the ratio of the emission range of radiation bundle on the cathode side is set greater than that of the emission range of radiation bundle on the anode side.

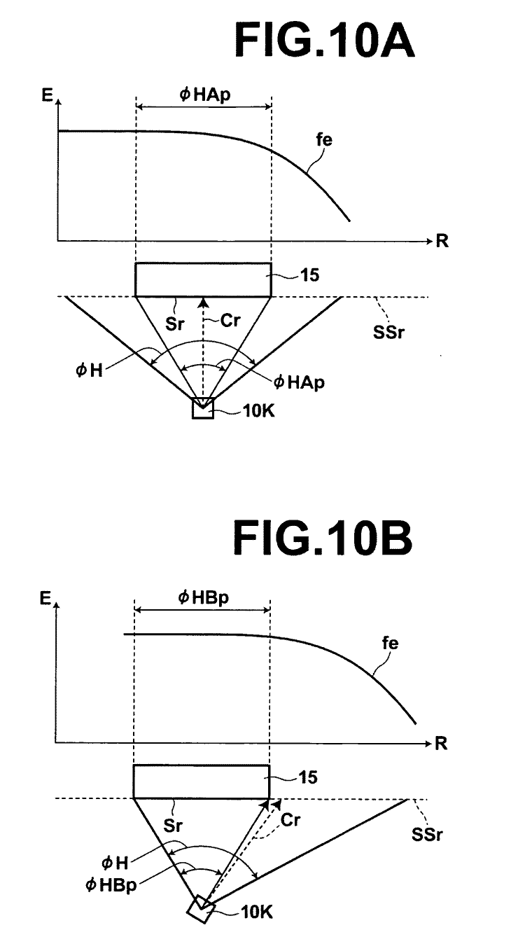

FIG. 10A illustrates an intensity distribution when radiation bundle emitted from a tube is detected with the emission center axis arranged orthogonal to the detection plane. That is, FIG. 10A depicts the state in which radiation bundle (pH is emitted from tube 10K with emission center axis Cr placed in the center of the width of detection surface Sr of radiation image detector 15.

FIG. 10B illustrates an intensity distribution when radiation bundle emitted from a tube is detected with the emission center axis arranged inclined to the detection plane. That is, FIG. 10B depicts the state in which radiation bundle pH is emitted from tube 10K by changing the orientation of tube 10K such that emission center axis Cr is placed at a position displaced from the center of the width of detection surface Sr of radiation image detector 15.

The lower portion of FIG. 10A or 10B depicts the state in which radiation bundle pH outputted from tube 10K of radiation source 10 is emitted on area SSr along detection surface Sr of radiation image detector 15 (along the moving direction of radiation image detector 15).

The graph in the upper portion of FIG. 10A or 10B illustrates intensity distribution fe of radiation bundle pH outputted from tube 10K and emitted on area SSr plotted in coordinates with horizontal axis R representing the position in area SSr along detection surface Sr of radiation image detector 15 and vertical axis E representing the intensity of the radiation emitted on area SSr.

Here, in each of FIGS. 10A and 10B, the position in area SSr to which radiation bundle φH is emitted shown in the lower portion corresponds to the position on horizontal axis R of intensity distribution fe in the graph shown in the upper portion.

As shown in FIG. 10A, when radiation bundle φH is emitted on area SSr by placing emission center axis Cr in the center of the width of detection surface Sr of radiation image detector 15, a portion of radiation bundle φH, radiation bundle portion φHAₚ, is emitted on detection surface Sr of radiation image detector 15. The radiation intensity distribution in radiation bundle portion φHAₚ is not constant but slanted due to heel effect as illustrated in FIG. 10A. That is, the intensity distribution of the radiation bundle is substantially constant on the cathode side from the center of detection surface (emission center axis Cr), but the intensity of the radiation bundle is monotonically decreasing on the anode side from the center of detection surface Sr (emission center axis Cr).

In the mean time, as shown in FIG. 10B, when radiation bundle pH is emitted on area SSr along the detection surface sr by displacing emission center axis Cr from the center of the width of detection surface Sr of radiation image detector 15 to the anode side, a cathode side portion of radiation bundle pH, radiation bundle portion φHBₚ, is emitted on detection surface Sr of radiation image detector 15. The radiation intensity distribution in radiation bundle portion φHBₚ is substantially constant since radiation bundle portion φHBₚ includes more radiation beams which are less influenced by heel effect. That is, radiation bundle portion φHBₚ which includes more radiation beams generated on the cathode side than those generated on the anode side is less influenced by the heel effect than radiation bundle portion φHAₚ which equally includes radiation beams generated on the anode side and those generated on the cathode side.

Radiation bundle portion φHBₚ having small emission unevenness due to heel effect in radiation bundle φH outputted from tube 10K may be emitted on detection surface SSr by changing the orientation of tube 10K by tube bobbing unit 19. Consequently, the photographing width and the like may be determined on the assumption that radiation bundle portion φHBₚ is emitted to each area of subject M in each radiographing operation.

When performing radiographing, it is preferable to block unwanted radiation beams by collimator 12 of radiation source 10 in order to prevent an area other than the photographing target area of subject M corresponding to the photographing width in each radiographing operation from being exposed by the radiation.

Preferably, the photographing width is determined such that each of adjacent image portions representing each area of subject M includes a portion in common. That is, by obtaining each image portion in which a part of each of adjacent image portions is overlapped with each other (for ensuring a tab for sticking), a plurality of image portions may be combined more easily.

As described above, photographable width obtaining unit 84 is a unit that determines the photographable width such that, for example, the smaller the focus size of the tube, the smaller the photographable width. When a radiation bundle on the anode side is used, photographable width obtaining unit 84 determines the photographable width when tungsten is used for the tube target smaller than that when molybdenum is used for the tube target. Further, photographable width obtaining unit 84 determines the photographable width such that the greater the radiation dose, the smaller the photographable width, and the smaller the photographing distance, the smaller the photographable width.

In the embodiment, a radiation image photographing apparatus that performs long length photographing in the upright position has been described, but the present invention is not limited to this and is applicable to a radiation image photographing apparatus that performs long length photographing in the supine position.

As described above, according to the present invention, a high quality long length radiation image without any noticeable step density difference at a joint portion may be obtained easily.

What is claimed is:

1. A radiation image photographing apparatus for obtaining a long length radiation image representing the entirety of a subject by combining a plurality of images obtained by serially radiographing a plurality of adjacent areas of the subject using the same radiation source and the same radiation image detector, the apparatus comprising:
a photographing condition obtaining unit for obtaining a photographing condition for performing each radiographing;
a photographable range obtaining unit for obtaining a photographable width in a long length direction in each radiographing from the photographing condition; and
an allocation unit for allocating the plurality of areas of the subject such that a photographing width in the long length direction in each radiographing operation does not exceed the photographable width.

2. The radiation image photographing apparatus of claim 1, wherein the photographing condition is a photographing distance.

3. The radiation image photographing apparatus of claim 1, wherein the photographing condition is a dose of radiation emitted from the radiation source.

4. The radiation image photographing apparatus of claim 1, wherein the photographing condition is a tube focus size of the radiation source.

5. The radiation image photographing apparatus of claim 1, wherein the photographing condition is a tube target material of the radiation source.

6. The radiation image photographing apparatus of claim 1, wherein the photographable range obtaining unit is a unit that obtains the photographable width when a radiation bundle portion having smallest emission unevenness due to heel effect in a radiation bundle outputted from the radiation source is emitted to each area of the subject.

7. The radiation image photographing apparatus of claim 2, wherein the photographable range obtaining unit is a unit that obtains the photographable width when a radiation bundle portion having smallest emission unevenness due to heel effect in a radiation bundle outputted from the radiation source is emitted to each area of the subject.

8. The radiation image photographing apparatus of claim 3, wherein the photographable range obtaining unit is a unit that obtains the photographable width when a radiation bundle portion having smallest emission unevenness due to heel effect in a radiation bundle outputted from the radiation source is emitted to each area of the subject.

9. The radiation image photographing apparatus of claim 4, wherein the photographable range obtaining unit is a unit that obtains the photographable width when a radiation bundle portion having smallest emission unevenness due to heel effect in a radiation bundle outputted from the radiation source is emitted to each area of the subject.

10. The radiation image photographing apparatus of claim 5, wherein the photographable range obtaining unit is a unit that obtains the photographable width when a radiation bundle portion having smallest emission unevenness due to heel effect in a radiation bundle outputted from the radiation source is emitted to each area of the subject.

11. The radiation image photographing apparatus of claim 6, further comprising a tube bobbing unit for changing an orientation of the tube of the radiation source.

12. The radiation image photographing apparatus of claim 7, further comprising a tube bobbing unit for changing an orientation of the tube of the radiation source.

13. The radiation image photographing apparatus of claim 8, further comprising a tube bobbing unit for changing an orientation of the tube of the radiation source.

14. The radiation image photographing apparatus of claim 9, further comprising a tube bobbing unit for changing an orientation of the tube of the radiation source.

15. The radiation image photographing apparatus of claim 10, further comprising a tube bobbing unit for changing an orientation of the tube of the radiation source.

16. A radiation image photographing method for obtaining a long length radiation image representing the entirety of a subject by combining a plurality of images obtained by serially radiographing a plurality of adjacent areas of the subject using the same radiation source and the same radiation image detector, the method comprising the steps of:
obtaining a photographing condition for performing each radiographing operation;
obtaining a photographable width in a long length direction in each radiographing from the photographing condition; and
allocating the plurality of areas of the subject such that a photographing width in the long length direction in each radiographing does not exceed the photographable width.
